(19) United States
(12) Patent Application Publication
(10) Pub. No.: US 2020/0354007 A1
(43) Pub. Date: Nov. 12, 2020

(54) NOVEL ELECTRIC DOUBLE-WHEEL BALANCE CAR

(71) Applicants: Ye Hu, Yongkang (CN); Min Ying, Yongkang (CN)

(72) Inventors: Ye Hu, Yongkang (CN); Min Ying, Yongkang (CN)

(21) Appl. No.: 16/521,611

(22) Filed: Jul. 25, 2019

(30) Foreign Application Priority Data
May 7, 2019 (CN) 201910405142.9

(51) Int. Cl. B62K 11/00; B60L 50/60; B62K 23/08

(52) U.S. Cl. CPC B62K 11/007; B60L 50/66; B62K 23/08; B62K 2208/00; B62K 2202/00; B62K 2207/00; B60L 2200/16

(57) ABSTRACT

The present invention discloses a novel electric double-wheel balance car, comprising a bottom plate, a first wheel, a second wheel, a first pedal group and a second pedal group. The first wheel is provided with a first motor shaft connected with a first motor. The second wheel is provided with a second motor shaft connected with a second motor. The present invention has the characteristics that the first motor shaft is fixedly connected with the first pedal group, and the second motor shaft is fixedly connected with the second pedal group. The present invention has the advantages that the integral structure is simpler; assembly is more convenient; the bottom plate shares human gravity and bears uniform stress; the integral structure is durable, simpler to control and easy for a beginner to use; and motion states are respectively independently controlled by left foot and right foot.

### TECHNICAL FIELD

The present invention relates to a novel electric double-wheel balance car.

### BACKGROUND

An electric balance car, also known as a somatosensory car, a thinking car and a segway, is a transportation tool that is popular with modern people, and can meet people's needs for leisure, entertainment and green health. Based on the principle of “dynamic stabilization”, the electric balance car uses a gyroscope and an acceleration sensor inside a car body to judge the posture state of the car body. After an appropriate command is calculated through a precise and high-speed central microprocessor, a motor is driven to make corresponding adjustment to maintain system balance. The existing balance car generally comprises a left pedal and a right pedal which are connected through an intermediate shaft in a form similar to a swingcar. Namely, two wheels are respectively connected with the shafts. Two different shafts are connected in the middle, and have fixed pedal positions. The entire pedal (i.e., the entire shaft) is rotated to control the balance car to move forward and backward and turn, which needs to control two rotary pedals at the same time. Thus, such balance car requires the user to have good hand and foot coordination to control, and is difficult to control. During use, the intermediate shaft bears all the gravity of the human body; the swing of the balance car body easily damages the intermediate shaft; and the intermediate shaft may even be broken. The balance car of this structure is easy to fail and has low stability. Another balance car comprises a transverse connecting piece. A left pedal and a right pedal are arranged on the transverse connecting piece. Four first elastic elements are arranged between the left pedal and the transverse connecting piece. Four second elastic elements are arranged between the right pedal and the transverse connecting piece. However, this structure has too many elastic elements, and is complicated in the overall structure and is very inconvenient in assembly.

### SUMMARY

A technical problem to be solved by the present invention is to provide a novel electric double-wheel balance car which is easy to control, durable, simple in structure and more convenient in assembly.

A technical solution adopted to solve the above technical problems by the present invention is as follows: a novel electric double-wheel balance car comprises a bottom plate, a first wheel, a second wheel, a first pedal group and a second pedal group, wherein the first wheel and the second wheel are respectively arranged on both sides of the bottom plate; a first motor is arranged in the first wheel; a first motor shaft connected with the first motor is arranged on the first wheel; a second motor is arranged in the second wheel; a second motor shaft connected with the second motor is arranged on the second wheel; a first control board is arranged in the first pedal group; a second control board is arranged in the second pedal group; the first motor shaft extends from one side of the bottom plate and then is penetrated in the first pedal group and is fixedly connected with the first pedal group; and the second motor shaft extends from the other side of the bottom plate and then is penetrated in the second pedal group and is fixedly connected with the second pedal group.

A further preferred solution of the present invention is as follows: the first pedal group comprises a first pedal and a first connecting part which are adapted; the first connecting part is arranged on the bottom plate and is rotatably matched with the bottom plate; the first pedal is arranged at the upper end of the first connecting part; the first control board is arranged in the first connecting part; the first connecting part is fixedly connected with the first motor shaft; the second pedal group comprises a second pedal and a second connecting part which are adapted; the second connecting part is arranged on the bottom plate and is rotatably matched with the bottom plate; the second pedal is arranged at the upper end of the second connecting part; the second control board is arranged in the second connecting part; and the second connecting part is fixedly connected with the second motor shaft.

A further preferred solution of the present invention is as follows: the side wall of the first motor shaft is provided with a first limiting surface; the first connecting part is provided with a first limiting plate and a second limiting plate; the first limiting plate is pressed on the first limiting surface and is locked with the first connecting part by a screw; the second limiting plate is pressed on the first limiting surface and is locked with the first connecting part by a screw; the side wall of the second motor shaft is provided with a second limiting surface; the second connecting part is provided with a third limiting plate and a fourth limiting plate; the third limiting plate is pressed on the second limiting surface and is locked with the second connecting part by a screw; and the fourth limiting plate is pressed on the second limiting surface and is locked with the second connecting part by a screw.

A further preferred solution of the present invention is as follows: the first connecting part is provided with a first installing groove adapted with the first motor shaft; the middle part of the first limiting plate is provided with an inverted U-shaped first clamping groove adapted with the first limiting surface; the first installing groove and the first clamping groove form a fixed installing hole of the first motor shaft; the first connecting part is provided with a second installing groove adapted with the first motor shaft; the middle part of the second limiting plate is provided with an inverted U-shaped second clamping groove adapted with the first limiting surface; the second installing groove and the second clamping groove form a fixed installing hole of the first motor shaft; the second connecting part is provided with a third installing groove adapted with the second motor shaft; the middle part of the third limiting plate is provided with an inverted U-shaped third clamping groove adapted with the second limiting surface; the third installing groove and the third clamping groove form a fixed installing hole of the second motor shaft; the second connecting part is provided with a fourth installing groove adapted with the second motor shaft; the middle part of the fourth limiting plate is provided with an inverted U-shaped fourth clamping groove adapted with the second limiting surface; and the fourth installing groove and the fourth clamping groove form a fixed installing hole of the second motor shaft.

A further preferred solution of the present invention is as follows: a first elastic sheet is arranged between the first connecting part and the bottom plate; the first elastic sheet is pressed on the first motor shaft; a second elastic sheet having the same structure as the first elastic sheet is arranged between the second connecting part and the bottom plate; the second elastic sheet is pressed on the second motor shaft; a first fixing seat and a second fixing seat are arranged at one side of the bottom plate and on the front and the rear ends; both ends of the first elastic sheet respectively penetrate out of the first connecting part and then are fixedly connected with the first fixing seat and the second fixing seat; the middle part of the first elastic sheet is pressed on the first limiting surface; a third fixing seat and a fourth fixing seat are arranged at the other side of the bottom plate and on the front and the rear ends; both ends of the second elastic sheet respectively penetrate out of the second connecting part and then are fixedly connected with the third fixing seat and the fourth fixing seat; and the middle part of the second elastic sheet is pressed on the second limiting surface. The function of an elastic steel sheet is to maintain the balance between the pedal and the bottom plate.

A further preferred solution of the present invention is as follows: the first elastic sheet comprises a first limiting part; the first limiting part is pressed On the first limiting surface; both ends of the first limiting part are bent downwards and then are integrally provided with first clamping parts in an extending mode along a horizontal direction; the first connecting part is provided with a first clamping hole; the first clamping part is penetrated in the first clamping hole; the outer ends of the two first clamping parts are tilted downwards and are integrally provided with first extending parts in an extending mode; the two first extending parts are integrally provided with first fixing parts in an extending mode along the horizontal direction; the two first fixing parts are respectively fixedly connected with the first fixing seat and the second fixing seat; the second elastic sheet comprises a second limiting part; the second limiting part is pressed on the second limiting surface; both ends of the second limiting part are bent downwards and then are integrally provided with second clamping parts in an extending mode along the horizontal direction; the second connecting part is provided with a second clamping hole; the second clamping part is penetrated in the second clamping hole; the outer ends of the two second clamping parts are tilted downwards and are integrally provided with second extending parts in an extending mode; the two second extending parts are integrally provided with second fixing parts in an extending mode along the horizontal direction; and the two second fixing parts are respectively fixedly connected with the third fixing seat and the fourth fixing seat.

A further preferred solution of the present invention is as follows: the first wheel group comprises a first wheel and a first motor shaft which are fixedly connected; the bottom plate is fixedly provided with a first motor rotating shaft sheath and a second motor rotating shaft sheath; the first motor rotating shaft sheath is provided with a first through hole; the second motor rotating shaft sheath is provided with a second through hole; the first motor shaft is penetrated in the first through hole and the second through hole and is rotatably matched therewith; the second wheel group comprises a second wheel and a second motor shaft which are fixedly connected; the bottom plate is fixedly provided with a third motor rotating shaft sheath and a fourth motor rotating shaft sheath; the third motor rotating shaft sheath is provided with a third through hole; the fourth motor rotating shaft sheath is provided with a fourth through hole; and the second motor shaft is penetrated in the third through hole and the fourth through hole and is rotatably matched therewith.

A further preferred solution of the present invention is as follows: the middle part of the bottom plate is provided with a battery electrically connected with the first control board and the second control board; and the bottom plate is provided with a cover plate.

A further preferred solution of the present invention is as follows: the first elastic sheet and the second elastic sheet are elastic steel sheets.

A further preferred solution of the present invention is as follows: the material of the bottom plate is aluminum.

Compared with the prior art, the present invention has the advantages that the first pedal group and the second pedal group are not connected through the intermediate shaft; the first motor shaft extends into the bottom plate which is rotatably matched with the first motor shaft, and is fixedly connected with the first pedal group; and the second motor shaft extends into the bottom plate which is rotatably matched with the second motor shaft, and is fixedly connected with the second pedal group. Unlike the prior art, the motor shaft is used to replace the traditional pedal rotating shaft; the length of the motor shaft is longer than that of the traditional structure; and redundant components are reduced. The integral structure is simpler; assembly is more convenient the bottom plate shares human gravity and bears uniform stress; the integral structure is durable, simpler to control and easy for a beginner to use; and motion states are respectively independently controlled by left foot and right foot.

### DESCRIPTION OF DRAWINGS

FIG. 1 is a structural schematic diagram of the present invention;

FIG. 2 is an exploded drawing of FIG. 1;

FIG. 3 is a local enlarged view of Position A in FIG. 2;

FIG. 4 is a local enlarged view of Position B in FIG. 2;

FIG. 5 is a local structural schematic diagram of the present invention; and

FIG. 6 is a structural schematic diagram of a first elastic sheet of the present invention.

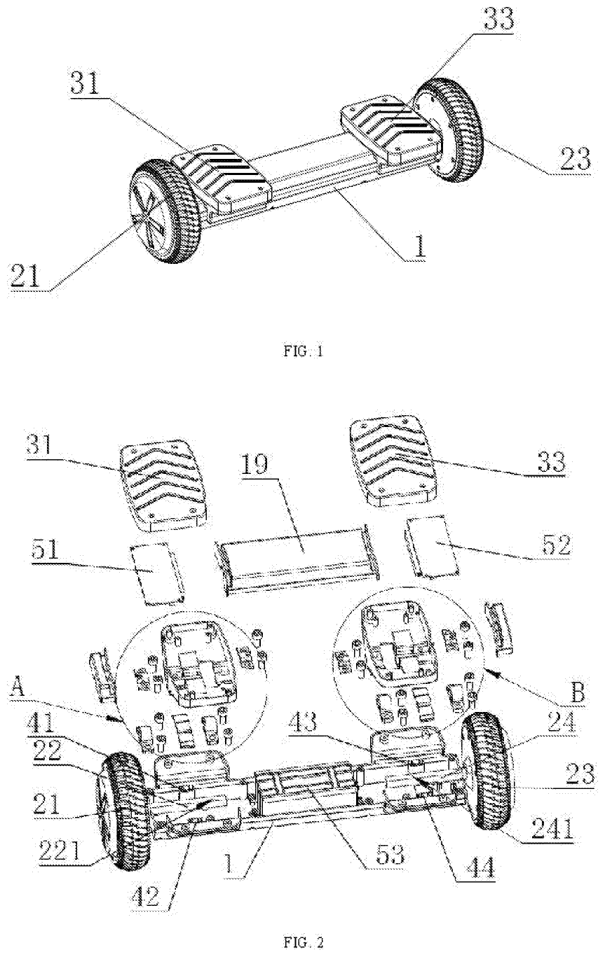

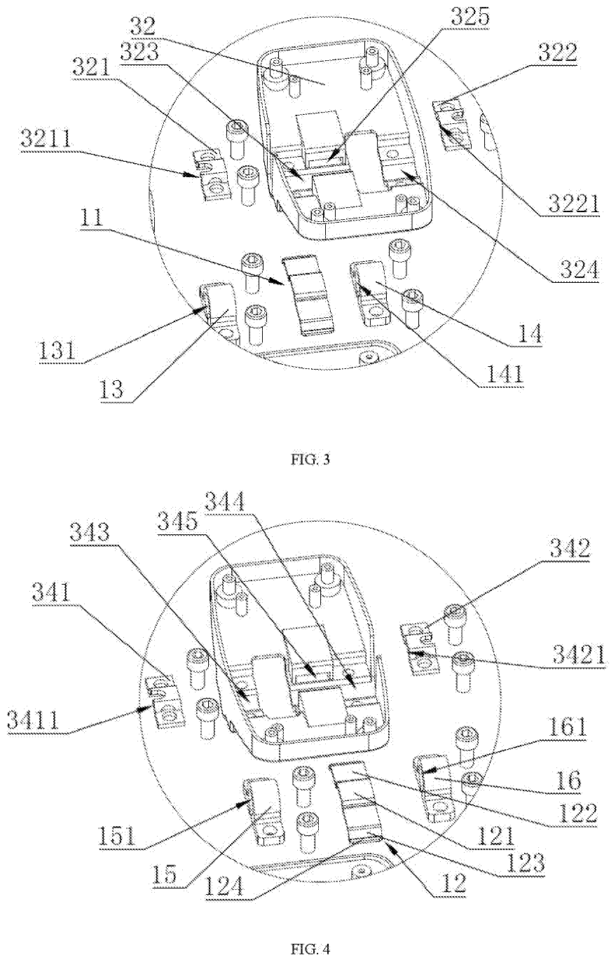

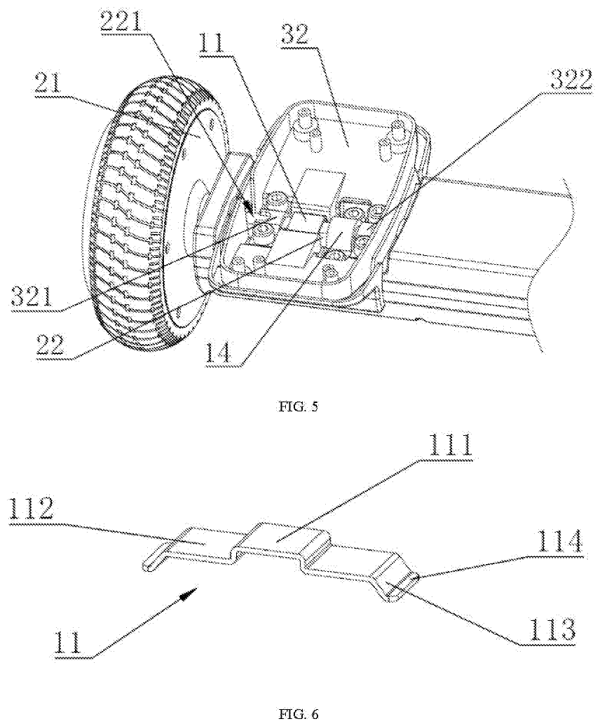

### DETAILED DESCRIPTION

The present invention is further described below in detail in combination with the drawings and embodiments.

As shown in the figures, a novel electric double-wheel balance car comprises a bottom plate 1, a first wheel 21, a second wheel 23, a first pedal group and a second pedal group. The first wheel 21 and the second wheel 23 are respectively arranged on both sides of the bottom plate 1; a first motor is arranged in the first wheel 21; a first motor shaft 22 connected with the first motor is arranged on the first wheel 23; a second motor is arranged in the second wheel 23; a second motor shaft 24 connected with the second motor is arranged on the second wheel 23; a first control board 51 is arranged in the first pedal group; a second control board 52 is arranged in the second pedal group; the first motor shaft 22 extends from one side of the bottom plate 1 and then is penetrated in the first pedal group and is fixedly connected with the first pedal group; and the second motor shaft 24 extends from the other side of the bottom plate 1 and then is penetrated in the second pedal group and is fixedly connected with the second pedal group. The first pedal group comprises a first pedal 31 and a first connecting part 32 which are adapted; the first connecting part 32 is arranged on the bottom plate 1 and is rotatably matched with the bottom plate 1; the first pedal 31 is arranged at the upper end of the first connecting part 32; the first control board 51 is arranged in the first connecting part 32; the first connecting part 32 is fixedly connected with the first motor shaft 22; the second pedal group comprises a second pedal 33 and a second connecting part 34 which are adapted; the second connecting part 34 is arranged on the bottom plate 1 and is rotatably matched with the bottom plate 1; the second pedal 33 is arranged at the upper end of the second connecting part 34; the second control board 52 is arranged in the second connecting part 34; and the second connecting part 34 is fixedly connected with the second motor shaft 22. The side wall of the first motor shaft 22 is provided with a first limiting surface 221; the first connecting part 32 is provided with a first limiting plate 321 and a second limiting plate 322; the first limiting plate 321 is pressed on the first limiting surface 221 and is locked with the first connecting part 32 by a screw; the second limiting plate 322 is pressed on the first limiting surface 221 and is locked with the first connecting part 32 by a screw; the side wall of the second motor shaft 24 is provided with a second limiting surface 241; the second connecting part 34 is provided with a third limiting plate 341 and a fourth limiting plate 342; the third limiting plate 341 is pressed on the second limiting surface 241 and is locked with the second connecting part 34 by a screw; and the fourth limiting plate 342 is pressed on the second limiting surface 241 and is locked with the second connecting part 34 by a screw. The first connecting part 32 is provided with a first installing groove 323 adapted with the first motor shaft; the middle part of the first limiting plate 321 is provided with an inverted U-shaped first clamping groove 3211 adapted with the first limiting surface 221; the first installing groove 323 and the first clamping groove 3211 form a fixed installing hole of the first motor shaft 22; the first connecting part 32 is provided with a second installing groove 324 adapted with the first motor shaft 22; the middle part of the second limiting plate 322 is provided with an inverted U-shaped second clamping groove 3221 adapted with the first limiting surface 221; the second installing groove 324 and the second clamping groove 3221 form a fixed installing hole of the first motor shaft 22; the second connecting part 34 is provided with a third installing groove 343 adapted with the second motor shaft 24; the middle part of the third limiting plate 341 is provided with an inverted U-shaped third clamping groove 3411 adapted with the second limiting surface 241; the third installing groove 343 and the third clamping groove 3411 form a fixed installing hole of the second motor shaft 24; the second connecting part 34 is provided with a fourth installing groove 344 adapted with the second motor shaft 24; the middle part of the fourth limiting plate 342 is provided with an inverted U-shaped fourth clamping groove 3421 adapted with the second limiting surface 241; and the fourth installing groove 344 and the fourth clamping groove 3421 form a fixed installing hole of the second motor shaft 24. A first elastic sheet 11 is arranged between the first connecting part 32 and the bottom plate 1; the first elastic sheet 11 is pressed on the first motor shaft 22; a second elastic sheet 12 having the same structure as the first elastic sheet 11 is arranged between the second connecting part 34 and the bottom plate 1; the second elastic sheet 12 is pressed on the second motor shaft 24; a first fixing seat 41 and a second fixing seat 42 are arranged at one side of the bottom plate 1 and on the front and the rear ends; both ends of the first elastic sheet 11 respectively penetrate out of the first connecting part 32 and then are fixedly connected with the first fixing seat 41 and the second fixing seat 42; the middle part of the first elastic sheet 11 is pressed on the first limiting surface 221; a third fixing seat 43 and a fourth fixing seat 44 are arranged at the other side of the bottom plate 1 and on the front and the rear ends; both ends of the second elastic sheet 12 respectively penetrate out of the second connecting part 34 and then are fixedly connected with the third fixing seat 43 and the fourth fixing seat 44; and the middle part of the second elastic sheet 12 is pressed on the second limiting surface 241. The first elastic sheet 11 comprises a first limiting part 111; the first limiting part 111 is pressed on the first limiting surface 221; both ends of the first limiting part 111 are bent downwards and then are integrally provided with first clamping parts 112 in an extending mode along a horizontal direction; the first connecting part 32 is provided with a first clamping hole 325; the first clamping part 112 is penetrated in the first clamping hole 325; the outer ends of the two first clamping parts 112 are tilted downwards and are integrally provided with first extending parts 113 in an extending mode; the outer ends of the two first extending parts 113 are integrally provided with first fixing parts 114 in an extending mode along the horizontal direction; the two first fixing parts 114 are respectively fixedly connected with the first fixing seat 41 and the second fixing seat 42; the second elastic sheet 12 comprises a second limiting part 121; the second limiting part 121 is pressed on the second limiting surface 241; both ends of the second limiting part 121 are bent downwards and then are integrally provided with second clamping parts 122 in an extending mode along the horizontal direction; the second connecting part 34 is provided with a second clamping hole 345; the second clamping part 122 is penetrated in the second clamping hole 345; the outer ends of the two second clamping parts 122 are tilted downwards and are integrally provided with second extending parts 123 in an extending mode; the two second extending parts 123 are integrally provided with second fixing parts 124 in an extending mode along the horizontal direction; and the two second fixing parts 124 are respectively fixedly connected with the third fixing seat 43 and the fourth fixing seat 44. The bottom plate 1 is fixedly provided with a first motor rotating shaft sheath 13 and a second motor rotating shaft sheath 14; the first motor rotating shaft sheath 13 is provided with a first through hole 131; the second motor rotating shaft sheath 14 is provided with a second through hole 141; the first motor shaft 22 is penetrated in the first through hole 131 and the second through hole 141 and is rotatably matched therewith; a second wheel group comprises a second wheel 23 and a second motor shaft 24 which are fixedly connected; the bottom plate 1 is fixedly provided with a third motor rotating shaft sheath 15 and a fourth motor rotating shaft sheath 16; the third motor rotating shaft sheath 15 is provided with a third through hole 151; the fourth motor rotating shaft sheath 16 is provided with a fourth through hole 161; and the second motor shaft 24 is penetrated in the third through hole 151 and the fourth through hole 161 and is rotatably matched therewith. The middle part of the bottom plate 1 is provided with a battery 53 electrically connected with the first control board 51 and the second control board 52; and the bottom plate 1 is provided with a cover plate 19. A drain groove is formed at a joint of the cover plate 19 the first pedal 31 and the second pedal 33. The first elastic sheet 11 and the second elastic sheet 12 are elastic steel sheets. The material of the bottom plate 1 is aluminum.

The power output end of the first motor is connected with the first wheel 21 in a driving mode. The first motor receives a signal transmitted by the first control board 51, and then controls the motion state of the first wheel 21. The power output end of the second motor is connected with the second wheel 23 in a driving mode. The second motor receives a signal transmitted by the second control board 52, and then controls the motion state of the second wheel 23. The first control board 51 is provided with a first sensing system. The second control board 52 is provided with a second sensing system. The first sensing system comprises a first sensing element and at least one touch sensing switch. The first sensing element senses the motion state of the first pedal group, and the signal output end of the first sensing element is connected with the signal input end of the first control board 51. The second sensing system comprises a second sensing element and at least one touch sensing switch. The second sensing element senses the motion state of the second pedal group, and the signal output end of the second sensing element is connected with the signal input end of the second control board 52. The first sensing element comprises a first gyroscope and a first acceleration sensor. The signal output end of the first gyroscope and the signal output end of the first acceleration sensor are connected with the signal input end of the first control board 51. The second sensing element comprises a second gyroscope and a second acceleration sensor. The signal output end of the second gyroscope and the signal output end of the second acceleration sensor are connected with the signal input end of the second control board 52.

Working principle: when the left pedal of a user is on the first pedal group, the first touch sensing switch is turned on; and when the right pedal is on the second pedal group, the second touch sensing switch is turned on. The left foot of the user steps on the first pedal group, so that the first pedal group is tilted forwards or backwards. At this moment, the first sensing element detects the motion state of the first pedal group at any time, and transmits the signal to the first control board. The first control board feeds back the signal to the first motor. The motion state of the first wheel is correspondingly adjusted according to the power output of the first motor. On the other hand, the right foot of the user steps on the second pedal group, so that the second pedal group is tilted forwards or backwards. At this moment, the second sensing element detects the motion state of the second pedal group, and transmits the signal to the second control board. The second control board feeds back the signal to the second motor. The motion state of the second wheel is correspondingly adjusted according to the power output of the second motor. When the user simultaneously strongly steps on the first pedal group and the second pedal group forwards, the first wheel and the second wheel keep rolling forwards, and the balance car moves forwards. When the user simultaneously strongly steps on the first pedal group and the second pedal group backwards, the first wheel and the second wheel keep rolling backwards, and the balance car moves backwards. When the stepping action of the user makes the motion states of the first pedal group and the second pedal group inconsistent, the balance car will turn. At the same time, the first sensing element and the second sensing element feed back the swinging amplitude of the body of the user, so that the first motor and the second motor obtain different power outputs, thereby adjusting the speed of the balance car.

The structures of the two pedal groups of the balance car may be the above structures, and may be identical or adopt the following structures: 1. other structures are the same as the above structures; and the differences are that: the motor shaft is broken; a section connected with the wheel is directly fixedly connected with the bottom plate, and the other section is fixedly connected with the pedal group through the above connecting structure; 2. other structures are the same as the above structures; and the differences are that: the motor shaft is broken; a section connected with the wheel extends from one side of the bottom plate and then is fixedly connected with one side of the pedal group; and the other section is fixedly connected with the other side of the pedal group through the above connecting structure; and 3. one pedal group is the above structure and is rotatably connected with the bottom plate, and the other pedal group is fixedly connected with the bottom plate.

The novel electric double-wheel balance car provided in the present invention is described in detail above. Specific individual cases are applied herein for elaborating the principle and embodiments of the present invention. The illustration of the above embodiments is merely used for helping to understand the present invention and the core thought. It should be noted that for those ordinary skilled in the art, several improvements and modifications can be made to the present invention without departing from the principles of the present invention, and these improvements and modifications shall also fall into the protection scope of claims of the present invention.

What is claimed is:

1. A novel electric double-wheel balance car, comprising a bottom plate, a first wheel, a second wheel, a first pedal group and a second pedal group, wherein the first wheel and the second wheel are respectively arranged on both sides of the bottom plate; a first motor is arranged in the first wheel; a first motor shaft connected with the first motor is arranged on the first wheel; a second motor is arranged in the second wheel; a second motor shaft connected with the second motor is arranged on the second wheel; a first control board is arranged in the first pedal group; a second control board is arranged in the second pedal group, characterized in that the first motor shaft extends from one side of the bottom plate and then is penetrated in the first pedal group and is fixedly connected with the first pedal group; and the second motor shaft extends from the other side of the bottom plate and then is penetrated in the second pedal group and is fixedly connected with the second pedal group.

2. The novel electric double-wheel balance car according to claim 1, characterized in that the first pedal group comprises a first pedal and a first connecting part which are adapted; the first connecting part is arranged on the bottom plate and is rotatably matched with the bottom plate; the first pedal is arranged at the upper end of the first connecting part; the first control board is arranged in the first connecting part; the first connecting part is fixedly connected with the first motor shaft; the second pedal group comprises a second pedal and a second connecting part which are adapted; the second connecting part is arranged on the bottom plate and is rotatably matched with the bottom plate; the second pedal is arranged at the upper end of the second connecting part; the second control board is arranged in the second connecting part; and the second connecting part is fixedly connected with the second motor shaft.

3. The novel electric double-wheel balance car according to claim 2, characterized in that the side wall of the first motor shaft is provided with a first limiting surface; the first connecting part is provided with a first limiting plate and a second limiting plate; the first limiting plate is pressed on the first limiting surface and is locked with the first connecting part by a screw; the second limiting plate is pressed on the first limiting surface and is locked with the first connecting part by a screw; the side wall of the second motor shaft is provided with a second limiting surface; the second connecting part is provided with a third limiting plate and a fourth limiting plate; the third limiting plate is pressed on the second limiting surface and is locked with the second connecting part by a screw; and the fourth limiting plate is pressed on the second limiting surface and is locked with the second connecting part by a screw.

4. The novel electric double-wheel balance car according to claim 3, characterized in that the first connecting part is provided with a first installing groove adapted with the first motor shaft; the middle part of the first limiting plate is provided with an inverted U-shaped first clamping groove adapted with the first limiting surface; the first installing groove and the first clamping groove form a fixed installing hole of the first motor shaft; the first connecting part is provided with a second installing groove adapted with the first motor shaft; the middle part of the second limiting plate is provided with an inverted U-shaped second clamping groove adapted with the first limiting surface; the second installing groove and the second clamping groove form a fixed installing hole of the first motor shaft; the second connecting part is provided with a third installing groove adapted with the second motor shaft; the middle part of the third limiting plate is provided with an inverted U-shaped third clamping groove adapted with the second limiting surface; the third installing groove and the third clamping groove form a fixed installing hole of the second motor shaft; the second connecting part is provided with a fourth installing groove adapted with the second motor shaft; the middle part of the fourth limiting plate is provided with an inverted U-shaped fourth clamping groove adapted with the second limiting surface; and the fourth installing groove and the fourth clamping groove form a fixed installing hole of the second motor shaft.

5. The novel electric double-wheel balance car according to claim 4, characterized in that a first elastic sheet is arranged between the first connecting part and the bottom plate; the first elastic sheet is pressed on the first motor shaft; a second elastic sheet having the same structure as the first elastic sheet is arranged between the second connecting part and the bottom plate; the second elastic sheet is pressed on the second motor shaft; a first fixing seat and a second fixing seat are arranged at one side of the bottom plate and on the front and the rear ends; both ends of the first elastic sheet respectively penetrate out of the first connecting part and then are fixedly connected with the first fixing seat and the second fixing seat the middle part of the first elastic sheet is pressed on the first limiting surface; a third fixing seat and a fourth fixing seat are arranged at the other side of the bottom plate and on the front and the rear ends; both ends of the second elastic sheet respectively penetrate out of the second connecting part and then are fixedly connected with the third fixing seat and the fourth fixing seat; and the middle part of the second elastic sheet is pressed on the second limiting surface.

6. The novel electric double-wheel balance car according to claim 5, characterized in that the first elastic sheet comprises a first limiting part; the first limiting part is pressed on the first limiting surface; both ends of the first limiting part are bent downwards and then are integrally provided with first clamping parts in an extending mode along a horizontal direction; the first connecting part is provided with a first clamping hole; the first clamping part is penetrated in the first clamping hole; the outer ends of the two first clamping parts are tilted downwards and are integrally provided with first extending parts in an extending mode; the outer ends of the two first extending parts are integrally provided with first fixing parts in an extending mode along the horizontal direction; the two first fixing parts are respectively fixedly connected with the first fixing seat and the second fixing seat; the second elastic sheet comprises a second limiting part; the second limiting part is pressed on the second limiting surface; both ends of the second limiting part are bent downwards and then are integrally provided with second clamping parts in an extending mode along the horizontal direction; the second connecting part is provided with a second clamping hole; the second clamping part is penetrated in the second clamping hole; the outer ends of the two second clamping parts are tilted downwards and are integrally provided with second extending parts in an extending mode; the outer ends of the two second extending parts are integrally provided with second fixing parts in an extending mode along the horizontal direction; and the two second fixing parts are respectively fixedly connected -with the third fixing seat and the fourth fixing seat.

7. The novel electric double-wheel balance car according to claim 1, characterized in that the bottom plate is fixedly provided with a first motor rotating shaft sheath and a second motor rotating shaft sheath; the first motor rotating shaft sheath is provided with a first through hole; the second motor rotating shaft sheath is provided with a second through hole; the first motor shaft is penetrated in the first through hole and the second through hole and is rotatably matched therewith; the bottom plate is fixedly provided with a third motor rotating shaft sheath and a fourth motor rotating shaft sheath; the third motor rotating shaft sheath is provided with a third through hole; the fourth motor rotating shaft sheath is provided with a fourth through hole; and the second motor shaft is penetrated in the third through hole and the fourth through hole and is rotatably matched therewith.

8. The novel electric double-wheel balance car according to claim 1, characterized in that the middle part of the bottom plate is provided with a battery electrically connected with the first control board and the second control board; and the bottom plate is provided with a cover plate.

9. The novel electric double-wheel balance car according to claim 5, characterized in that the first elastic sheet and the second elastic sheet are elastic steel sheets.

10. The novel electric double-wheel balance car according to claim 1, characterized in that the material of the bottom plate is aluminum.
